(19) United States
(12) Patent Application Publication
(10) Pub. No.: US 2008/0121630 A1
(43) Pub. Date: May 29, 2008

(54) Portable food container

(76) Inventor: Jo-Anne Simard, Laval (CA)

Correspondence Address: INVENTION QUEBEC INC.;Suite 202, 8065, Boul. Viau, Montreal, QC, H1R 2T2, omitted

(21) Appl. No.: 11/605,416

(22) Filed: Nov. 29, 2006

(51) Int. Cl. A21B 1/52; H05B 3/02; A47J 41/00; B65D 6/00

(52) U.S. Cl. 219/387; 219/482; 220/592.2; 220/4.27

(57) ABSTRACT

A portable food container for carrying and selectively heating a food article. The portable food container includes a first container section defining a first section outer surface, the container first section including a first section cavity for receiving the food article and a heat source for heating the food article when the food article is received in the first section cavity. The food container further includes a container second section defining a second section outer surface, the container second section including a second section cavity for receiving the food article. The container first and second sections are releasably attachable to each other about the first and second section outer surface so as to be jointly movable.

### FIELD OF THE INVENTION

The present invention relates generally to the field of food storage and is particularly concerned with a portable food container.

### BACKGROUND OF THE INVENTION

Portable food containers, also often called lunch boxes, are commonly used to carry food to be consumed, for example, during work or at any other places away from the home of an intended user. Among all currently existing portable food containers, some include a heating element for heating a food article to be consumed.

For example, such heated portable food containers are described in U.S. Pat. No. 3,808,401 issued on Apr. 30, 1974 to Wright et al. Also, another example of such a heated portable food container is found in U.S. Pat. No. 4,037,081 issued on Jul. 19, 1977 to Aldridge et al. Furthermore, U.S. Pat. No. 6,144,016 issued on Nov. 7, 2000 to Garvin also describes another portable lunch box including a heating element. Yet, furthermore, U.S. Pat. No. 6,541,738 issued on Apr. 1, 2003 to Casasola describes another portable food container with a heating element. Finally, U.S. Pat. No. 6,570,133 issued on May 27, 2003 to Grosso Sr. also describes a portable food container including a heating element.

However, the portable food containers described in these patents are typically relatively rigid and relatively voluminous. Therefore, they are relatively hard to store when they are not in use, especially when they contain cold food that must be maintained cold before being heated.

Also, most of the existing portable food containers that include a heating element must be stored along with food to maintain cool.

Yet, furthermore, most of the existing portable food containers including a heating element are not configured to easily maintain cold a food article while heating or maintaining hot another food article.

Accordingly, there exists a need for an improved portable food container.

It is a general object of the present invention to provide such a portable food container.

### SUMMARY OF THE INVENTION

In a first broad aspect, the invention provides a portable food container for carrying and selectively heating a food article. The portable food container includes a first container section defining a first section outer surface, the container first section including a first section cavity for receiving the food article and a heat source for heating the food article when the food article is received in the first section cavity. The food container further includes a container second section defining a second section outer surface, the container second section including a second section cavity for receiving the food article. The container first and second sections are releasably attachable to each other about the first and second section outer surface so as to be jointly movable.

When the container first and second sections are attached to each other, the container first and second sections are relatively easily jointly movable. When the container first and second sections are detached from each other, the container first and second sections are separately relatively easily movable. Therefore, the portable food container allows to easily carry the first and second sections while allowing the use of these containers first and second sections separately when an intended user arrives to a use site.

The container first and second sections each relatively ergonomic to use and also relatively ergonomic to use when attached to each other.

In some embodiments of the invention, the ergonomicity of the portable food container is improved through the presence of handles extending from the first and second sections outer surfaces.

Furthermore, in some embodiments of the invention, a thermal insulator for reducing heat transfer between the first and second section cavities is located between the first and second section cavities when the container first and second sections are attached to each other. Therefore, in these embodiments, it is relatively easy to maintain the food present in the container second section cool while maintaining the food present in the container first section hot.

Yet furthermore, this easiness of maintaining food at two different temperatures may be improved by locating the container first section above the container second section when the container first section heats the food article.

Yet furthermore, the portable food container is relatively easy to manufacture and relatively inexpensive.

In some embodiments of the invention, the portable food container is reversibly deformable so as to be relatively easy to store. For example, when the container second section is detached from the container first section and stored in a refrigerator, having a container second section that is relatively easy to deform allows to store the container in a relatively small volume if the container second section does not have a second section cavity that is totally filled with food. Therefore, it is easier to ensure that there is enough room in the refrigerator to contain the container second section. This ease of storage is further improved by the fact that the container first section is detachable from the container second section. Therefore, there is no need to store the heating element and its associated cavity along with the food to cool.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

An embodiment of the present invention will now be disclosed, by way of example, in reference to the following drawings in which:

FIG. 1, in a perspective view, illustrates a portable food container in accordance with an embodiment of the present invention, the portable food container including a container first section and a container second section shown attached to each other;

FIG. 2, in a perspective view, illustrates the portable food container of FIG. 1 with the container first and second sections detached from each other;

FIG. 3, in a perspective exploded view, illustrates the portable food container of FIG. 1;

FIG. 4, in a side elevation view, illustrates the portable food container of FIG. 1;

FIG. 5, in a front elevation view, illustrates the portable food container of FIG. 1;

FIG. 6, in a cross-sectional view, illustrates an outer wall of the container second section of FIG. 1; and

FIG. 7, in a side cross-sectional view, illustrates an outer wall of the container first section of FIG. 1.

### DETAILED DESCRIPTION

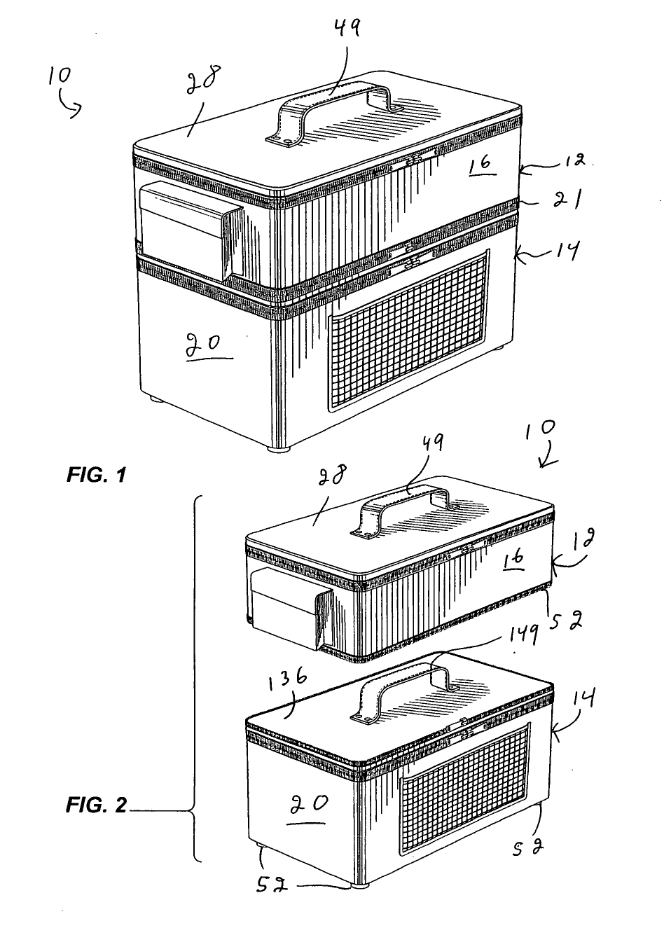

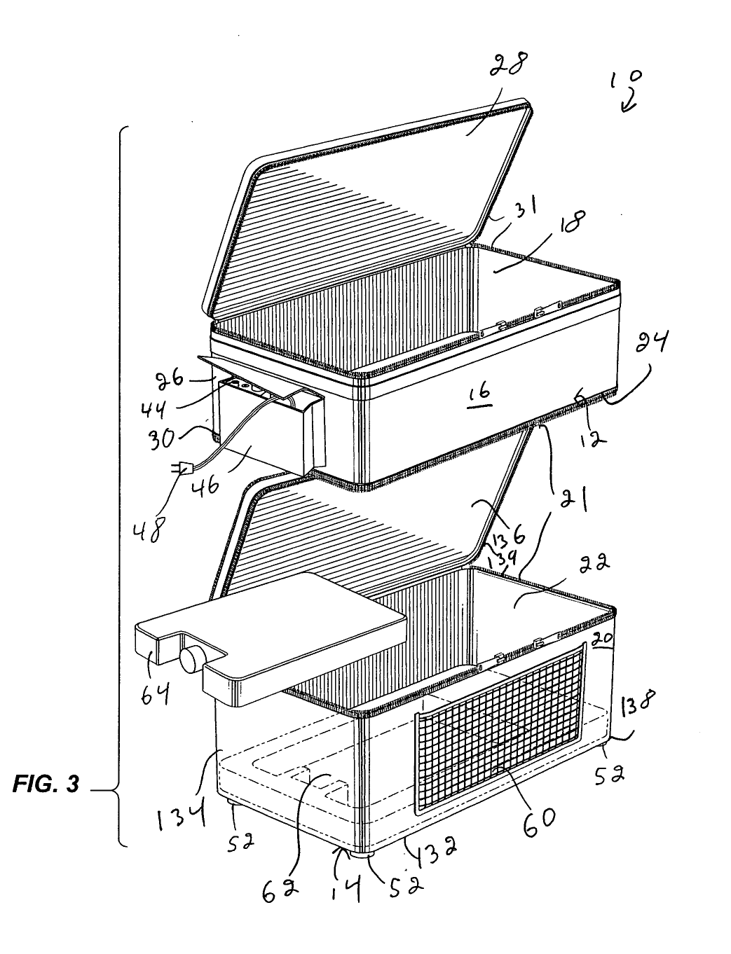

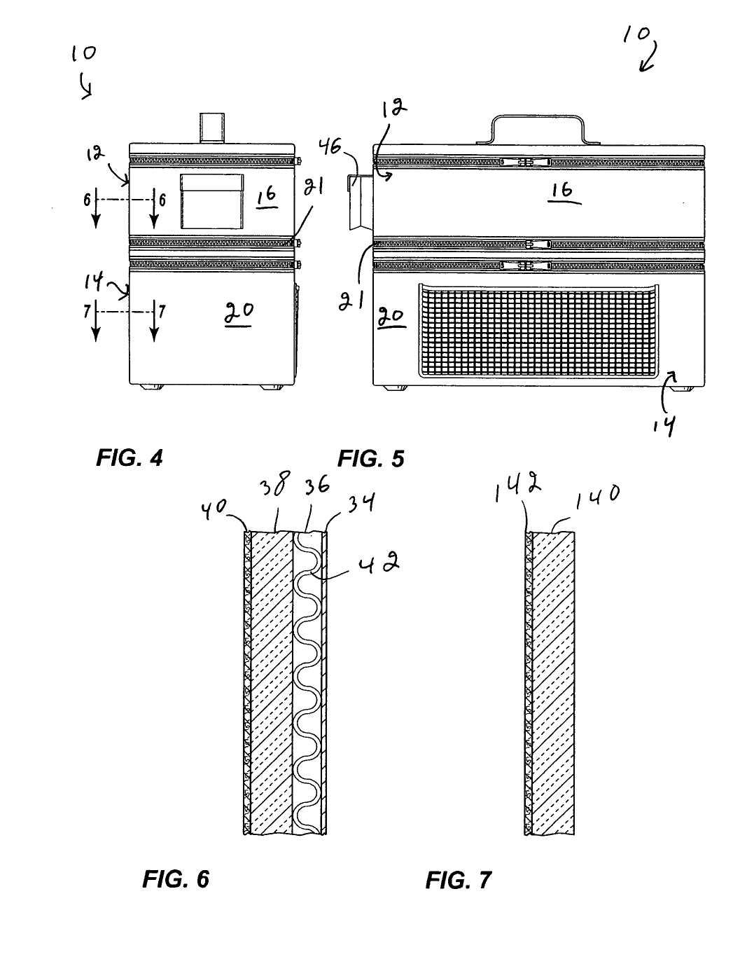

FIGS. 1 to 5 illustrate a portable food container 10 for carrying and selectively heating a food article (not shown in the drawings). Referring to FIG. 3, the portable food container 10 includes a container first section 12 and a container second section 14. The container first section 12 defines a first section outer surface 16. The container first section 12 includes a first section cavity 18 for receiving the food article. The container first section 12 also includes a heat source (illustrated in FIG. 7) for heating the food article when the food article is received in the first section cavity 18.

The container second section 14 defines a second section outer surface 20. The container second section 18 includes a second section cavity 22 for receiving the food article.

The container first and second sections 12 and 14 are relatively attachable to each other about the first and second section outer surfaces 16 and 20. When the container first and second sections are attached to each other, as seen in FIG. 1, they are jointly movable. When the container first and second sections are detached from each other, as seen in FIG. 2, they are movable separately from each other.

In the present description, directional term such as top and bottom, for example, are used for clarity reasons and should not be used to restrict the scope of the appended claims.

In some embodiments of the invention, the container first and second sections 12 and 14 are configured and sized so as to be operable with the container first section 16 attached to and located above the container second section 14. However, in alternative embodiments of the invention, the container first and second sections 12 and 14 are positionable in any other suitable relative position.

The container first and second sections 12 and 14 are releasably attachable to each other in any suitable manner. For example, as seen in the drawings, the container first and second sections 14 are attachable to each other through a zip-type fastener 21.

In some embodiments of the invention, a thermal insulator for reducing heat transfer between the first and second section cavities 18 and 22 is located between the first and second section cavities 18 and 22 when the container first and second sections 12 and 14 are attached to each other. However, in alternative embodiments of the invention, no thermal insulator is provided.

For example, the thermal insulator includes an aluminized polymer sheet located between the container first and second sections 12 and 14. In some embodiments of the invention, the thermal insulator includes a sheet of an infrared radiation reflecting material that surrounds the first section cavity 18 for reducing heat transfer between the first section outer surface 16 and the first section cavity 18. Therefore, in these embodiments of the invention, not only is heat transfer reduced between the first and second container sections 12 and 14, but heat transfer is also reduced from within the first section cavity 18 and outside the first section cavity 18. Furthermore, in some embodiments of the invention, a thermal insulator also substantially surrounds the second section cavity 22 for reducing heat transfer between the second section outer surface 20 and the second section cavity 22. The thermal insulators are described in further details hereinbelow.

Referring to FIG. 3, the container first section 12 includes a first section bottom wall 24, a first section peripheral wall 26 extending substantially outwardly from the first section bottom wall 24 and a first section top wall 28. In some embodiments of the invention, the first section top wall 28 forms a first section lid that is hingedly attached at the periphery thereof to the first section peripheral wall 26. In these embodiments of the invention, the first section bottom and peripheral walls 24 and 26 form a first section base 30.

The first section lid is movable between an open configuration and a closed configuration. In the open configuration, access to the first section cavity 18 is allowed and, in the closed configuration, access to the first section cavity 18 is prevented. In some embodiments of the invention, the first section lid is reversibly lockable to the first section base in a closed configuration through the use of a zip-type fastener 31.

The first section bottom, peripheral and top walls 24, 26 and 28 have a layered structure, as shown in FIG. 7. Proceeding outwardly from the first section cavity 18 towards the first section outer surface 16, the structure layer includes an inner layer 34, a heat radiating layer 36, a heat insulating layer 38 and an outer layer 40. In some embodiments of the invention, the inner and outer layers 34 and 40 are made of material that is substantially waterproof and relatively easily cleaned if it becomes soiled. The heat radiating layer 36 includes a radiant element 42 for radiating heat. For example, the radiant element 42 is a substantially flexible element. Finally, as mentioned hereinabove, the thermally insulating layer 38 may, for example, include an aluminized polymer that acts as a thermal insulator.

Referring to FIG. 3, the portable food container 10 further includes a power supply and temperature control unit 44 for supplying electrical power to the radiant element 42 and controlling the temperature inside the first section cavity 18. The control unit 44 may be provided at any suitable location relatively to the first section cavity 18. For example, a control unit receptacle 46 extends from the first section outer surface 16 for receiving the control unit 44 thereinto. A power cord 48 extends from the control unit 44 and is pluggable into a conventional electrical outlet.

Positioning the control unit 44 outside of the cavity 18 and especially outwardly relatively to the heat insulating layer 38 ensures that thermal regulation of the temperature of the control unit 44 is relatively easy to achieve so that electronic electrical components contained into the control unit 44 remain relatively cool and especially remain within an operational temperature range suggested by the manufacturers of such components. Furthermore, the location of the control unit 44 ensures that it is relatively easily accessible by an intended user of the portable food container 10.

The control unit 44 is electrically linked to the radiant element 42 and supplies power at a suitable level thereto. In some embodiments of the invention, the control unit 44 includes temperature sensing components (not shown in the drawings) extending into the first container cavity 18 for measuring a temperature inside the first container cavity 19. The temperature sensing components allow the control unit 44 to maintain the temperature inside the first section cavity 18 above a predetermined temperature as the level of the power supplied to the radiant element 42 may be adjusted so that the predetermined temperature is maintained.

Indeed, in the food industry, there is an interval of temperatures within which it is undesirable to maintain food at it promotes bacteria growth. This temperature interval is usually fixed through regulations by government officials. Typically, below this temperature range, bacteria growth is greatly slowed as the temperature is relatively low. Above this temperature range, it is safe to maintain the food at that temperature as the temperature is large enough that most human disease causing bacteria are killed. In a specific embodiment of the invention, the control unit 44 maintains a temperature inside the first section cavity 18 above 60 Celsius.

Other features of the container first section 12 are also present in some embodiments of the invention. Referring to FIG. 1, a first section handle 49 extends outwardly from the first section top wall 28. Also, although not shown in the drawings, in some embodiments of the invention, substantially disc-shaped feet extend substantially downwardly from the first section bottom wall 24.

Referring to FIG. 3, the container second section 14 includes a second section bottom wall 132, a second section peripheral wall 134 extending substantially outwardly from the second section bottom wall 132 and a first section top wall 136. In some embodiments of the invention, the second section top wall 136 forms a second section lid that is hingedly attached at the periphery thereof to the second section peripheral wall 134. In these embodiments of the invention, the second section bottom and peripheral walls 132 and 134 form a second section base 138.

The second section lid is movable between an open configuration and a closed configuration. In the open configuration, access to the second section cavity 22 is allowed and, in the closed configuration, access to the second section cavity 22 is prevented. In some embodiments of the invention, the second section lid is reversibly lockable to the second section base 38 in a closed configuration through the use of a zip-type fastener 139.

The second section bottom, peripheral and top walls 132, 134 and 136 have a layered structure, as shown in FIG. 6. Proceeding outwardly from the second section cavity 22 towards the second section outer surface 20, the layered structure includes a thermally insulating layer 140 and an outer layer 142. In some embodiments of the invention, a heat insulating layer 140 and an outer layer 142 include a material that is substantially waterproof and relatively easily cleaned if it becomes soiled. Finally, as mentioned hereinabove, the thermally insulating layer 140 may, for example, include an aluminized polymer that acts as a thermal insulator.

Other features of the container second section 14 are also present in some embodiments of the invention. Referring to FIG. 2, a second section handle 149 extends outwardly from the second section top wall 28. Also, referring to FIGS. 2 and 3, substantially disc-shaped feet 52 extend substantially downwardly from the second section bottom wall 132.

Referring to FIG. 3, in some embodiments of the invention, a flap of material 60 is affixed to the outer surface 20 in the region of the outer surface 20 corresponding to the second section peripheral wall 134. For example, the flap of material 60 is made of a substantially net-like material that is relatively easily stretchable. Therefore the flap of material 60 forms a pocket for containing various elements that may be carried together with the portable food container 10.

In some embodiments of the invention, the second section bottom wall 132 defines a recess 62 for receiving thereinto a similarly shaped bottle 64. In some embodiments of the invention, the bottle 64 is shaped so that it does not extend upwardly above the remaining portions of the second section bottom wall 132. In other words, when the bottle 64 is received into the recess 62, the second section bottom wall 132 is substantially flat.

In some embodiments of the invention, the first and second section outer walls 16 and 20 are substantially reversibly deformable.

In some embodiments of the invention, the control unit 44 and the heat radiating layer 36 are replaced by a volume of a material that may then radiate heat as it cools to heat the food article contained in the cavity 18.

In use, the portable food container 10 may be carried as a single unit through the handle 49 to a remote location. Then, the first and second container sections 12 and 14 may be separated from each other. In some embodiments of the invention, an intended user inserts a food article to be kept cold into the container second section 14 and either leaves the first section cavity 18 empty or inserts into the first section cavity 18 an article of food to be kept warm.

In some embodiments of the invention, the bottle 64 is filled with a cold liquid that may or may not be frozen prior to being inserted into the recess 62. Then, the liquid contained in the bottle 64 helps in maintaining cold the food contained in the second section cavity 22. In some embodiments of the invention, the bottle 64 is used to store water or juice that may be drunk.

Furthermore, if required, the container second section 14 may be stored in a refrigerator so as to maintain cold the food article contained thereinto.

The container first section 12 may be used to maintain at a suitable temperature the food article contained therein by plugging the electrical cord 48 into an electrical outlet and powering the control unit 44. In other embodiments of the invention, the first container section 12 is used to heat a food article prior to consumption, for example, a food article that was previously contained into the second section cavity 22.

In yet another embodiment of the invention, the heating element 42 is powerful enough to cook food contained into the first section cavity 12.

The thermal insulator present between the container first and second sections 12 and 14 ensures that it is relatively easy to maintain cold a food article contained into the second section cavity 22 while maintaining hot the food article contained into the first section cavity 18. This is possible even when the first and second container sections 12 and 14 are attached to each other. Furthermore, positioning the container first section 12 above the container second section 14 further helps maintaining this temperature difference as heated air is convected away from the second container section 14.

When the container first and second sections are attached to each other, the feet of the container first section 12, when present, and the handle 149 of the container second section 14 are inserted between the container first and second sections 12 and 14. Therefore, they are hidden and contribute to the easiness of transportation of the portable food container 10. Furthermore, having the container first and second sections 12 and 14 that are substantially reversibly deformable allows to manufacture the container first and second sections 12 and 14 relatively easily while allowing the feet of the container first section 12, when present, and the handle 149 to be compressed between the container first and second sections 12 and 14.

A synergistic effect is produced between the heating element 42 and the bottle 64 in that the portable food container 10 is usable to carry relatively easily and store a complete meal that includes both cold food and hot food.

Although the present invention has been described hereinabove by way of preferred embodiments thereof, it can be modified, without departing from the spirit and nature of the subject invention as defined in the appended claims.

What is claimed is:

1. A portable food container for carrying and selectively heating a food article, said portable food container comprising:
a container first section defining a first section outer surface, said container first section including a first section cavity for receiving the food article and a heat source for heating the food article when the food article is received in the first section cavity; and
a container second section defining a second section outer surface, said container second section including a second section cavity for receiving the food article;
said container first and second sections being releasably attachable to each other about said first and second section outer surfaces so as to be jointly movable.

2. A portable food container as defined in claim 1, further comprising a thermal insulator for reducing heat transfer between said first and second section cavities, said thermal insulator being located between said first and second section cavities when said container first and second sections are attached to each other.

3. A portable food container as defined in claim 2, wherein said thermal insulator includes an aluminized polymer.

4. A portable food container as defined in claim 2, wherein said thermal insulator includes a sheet of an infrared radiation reflecting material.

5. A portable food container as defined in claim 2, wherein said thermal insulator substantially surrounds said first section cavity for reducing heat transfer between said first section outer surface and said first section cavity.

6. A portable food container as defined in claim 2, wherein said thermal insulator substantially surrounds said second section cavity for reducing heat transfer between said second section outer surface and said second section cavity.

7. A portable food container as defined in claim 1, wherein said heat source includes a radiant element located between said first section cavity and said first section outer surface.

8. A portable food container as defined in claim 7, further comprising a power supply and temperature control unit for supplying electrical power to said radiant element and controlling the temperature inside said first section cavity.

9. A portable food container as defined in claim 8, wherein said power supply and temperature control unit controls said temperature inside said first section cavity so that said temperature inside said first section cavity selectively remains above a predetermined temperature.

10. A portable food container as defined in claim 9, further comprising a control unit receptacle for receiving said power supply and temperature control unit, said control unit receptacle extending substantially outwardly from said first section outer surface.

11. A portable food container as defined in claim 1, further comprising a flap of material attached to at least one of said first and second section outer surfaces, said flap of material forming a pocket.

12. A portable food container as defined in claim 1, wherein said container first section includes a first section base and a first section lid coupled to said first section base, said first section lid being movable between an open configuration and a closed configuration, wherein in said open configuration, access to said first section cavity is allowed and in said closed configuration, access to said first section cavity is prevented.

13. A portable food container as defined in claim 1, wherein said container second section includes a second section base and a second section lid coupled to said second section base, said second section lid being movable between an open configuration and a closed configuration, wherein in said open configuration, access to said second section cavity is allowed and in said closed configuration, access to said second section cavity is prevented.

14. A portable food container as defined in claim 13, wherein said container first section is releasably attachable to said second section lid.

15. A portable food container as defined in claim 13, further comprising a second section handle extending from said second section lid.

16. A portable food container as defined in claim 1, wherein at least one of said container first and second sections is substantially reversibly deformable.

17. A portable food container as defined in claim 1, comprising a zip-type fastener attached to at least one of said container first and second sections for releasably attaching said container first and second sections to each other.

18. A portable food container as defined in claim 1, wherein said container second section is usable in combination with a bottle, said second section cavity including a recess for receiving at least in part the bottle thereinto.

19. A portable food container as defined in claim 1, wherein said container first and second sections are configured and sized so as to be operable with said container first section attached to and located above said container second section.

20. A portable food container as defined in claim 1, wherein said container first section includes at least one foot for supporting said container first section over a surface, said container second section being configured and sized so that said at least one foot is located between said first and second section outer surfaces when said container first and second sections are attached to each other.
